(19) United States
(12) Patent Application Publication
(10) Pub. No.: US 2012/0089514 A1
(43) Pub. Date: Apr. 12, 2012

(54) METHOD OF AUTHENTICATION

(76) Inventors: Andreas Kraemling, Bonn (DE); Andreas Kompart, Hannover (DE); Thomas Bause, Hannover (DE)

(21) Appl. No.: 12/866,583

(22) PCT Filed: Jul. 9, 2009
(86) PCT No.: PCT/EP09/04986

§ 371 Date: Oct. 19, 2010

(30) Foreign Application Priority Data
Jul. 29, 2008 (DE) 10 2008 035 391.4

(51) Int. Cl. G06Q 40/02

(52) U.S. Cl. 705/42

(57) ABSTRACT

A method for authentication of a user (1) to an acceptance point (3), the authentication being performed by comparing a transaction number (Trx1D) with a computed or stored transaction number (Trx1D), wherein the acceptance point (3) and/or a user terminal (2) sends a request message to a central point (4) and the central point (4) provides and transmits a temporarily valid transaction number (Trx1D) by means of which authentication of the user (1) to the acceptance point (3) can be performed, or that the acceptance point (3) provides a temporarily valid transaction number (Trx1D) by means of which authentication of the user (1) to a central point (4) can be performed, an authorization after successful authentication to the central point (4) being performed by the generation and transmission of an authorization message from the central point (4) to the acceptance point (3).

The invention relates to a method of authentication of a user to an acceptance point, the authentication being performed by comparing a transaction number with a computed or stored transaction number.

Authentication methods of this kind are known and are used, for example, in online banking when using indexed transaction numbers. Here, the index, i.e. a first transaction number, is notified to the user who responds with the TAN, i.e. with the transaction authentication number representing the second transaction number or transaction ID. In this process, the transaction data are not linked together, and the TAN, i.e. the transaction authentication number, serves to sign the transaction, which is then triggered by this confirmation.

A disadvantage of the known methods is that they require prior registration of the user at the acceptance point, i.e. the user must be known to the acceptance point, with the result that a method of this kind cannot be performed anonymously. Furthermore, the corresponding TAN lists must be made available to the user in advance, which involves, in particular, the risk of misuse if the TAN list gets into the wrong hands.

The object of the invention is to provide a method of authentication of a user to an acceptance point that offers increased security of authentication and enables, in particular, the authentication of an anonymous user, i.e. a user who has not been previously registered with the acceptance point.

In accordance with the invention, this object is achieved by the authentication method set forth in claims 1.

Advantageous developments of the invention are given in the dependent claims.

Especially advantageous in the method according to the invention for authentication of a user to an acceptance point, the authentication being performed by comparing a transaction number with a computed or stored transaction number, is that the acceptance point and/or a user terminal sends a request message to a central point and the central point provides and transmits a temporarily valid transaction number by means of which authentication to the acceptance point can be performed, or that the acceptance point provides a temporarily valid transaction number by means of which authentication to a central point can be performed, an authorization after successful authentication to the central point being performed by the generation and transmission of an authorization message from the central point to the acceptance point.

These developments of the invention thus make it possible for an anonymous user to authenticate himself to an acceptance point, such as a vending machine or automatic cashier machine, or to an Internet server offering programs or files for download, the successful authentication then triggering a transaction or similar, in particular triggering or confirming a payment transaction.

Appropriate applications can be provided for this purpose on a terminal of the user and/or an appropriate application can be provided on a cash desk/checkout, a PC or similar serving as a vending machine or automatic cashier machine, etc.

In this respect, the term “anonymous user” means that the user does not require to be previously registered with or known to the acceptance point since the authentication procedure is performed by invoking a central point.

A central point, i.e. a central application can be provided which is responsible for controlling the triggering of the transaction and, in particular, a payment transaction and which brings the two anonymous parties together, that is to say that in handling the authentication of the user to the acceptance point in accordance with the invention, it is possible to trigger a transaction by invoking a central point without the user having to first register with the acceptance point.

The acceptance point can be any vending machine or automatic cashier machine or also an offering on the Internet. The authentication can then serve, for example, to check whether the user complies with any specified age limit for using the offerings and/or to trigger or confirm a payment transaction, or similar.

The security of the authentication process is assured in particular by the fact that permanently valid transaction numbers do not have to be provided, output and stored in advance but that in each case a temporarily valid transaction number is provided and transmitted by means of which an authentication can be performed. In a first variant, the authentication is performed directly to the acceptance point through provision and transmission of the temporarily valid transaction number by the central point.

Personal identification (password, ultimately also a single-use TAN) can additionally be requested from the user. The request for this personal identification can take place in every case or in a rule-based manner depending on the current situation (e.g. detection of misuse, transaction amount, number of transactions per time interval).

In the other variant of the method according to the invention, the temporarily valid transaction number is provided by the acceptance point so as to allow authentication to the central point, whereafter, following successful authentication to the central point, this central point then generates an authorization message and transmits this to the acceptance point.

This ensures a very high level of security of the authentication process.

Preferably, the request for provision and/or transmission of the transaction number is sent by the acceptance point to the central point and/or by a user terminal to the acceptance point and/or to the central point, in particular by a mobile telephone terminal having an appropriate authentication application.

Preferably, the authentication process is triggered by a user through a personal code, in particular a password, a single-use transaction number (Trx1D) or biometric identification, in particular a fingerprint or similar.

Preferably, the indication of a personal code for triggering the authentication process is required in every case or, alternatively, is requested depending on the current situation, in particular depending on the total turnover of the user within a time interval, the magnitude of the sum involved, the history of the customer, the type of the article and/or other customer-specific characteristics.

An increased level of security can be achieved in this way without it being apparent to the customer that the security level of the authentication process is variable and, in particular, can depend on predefinable parameters.

Preferably, the communication between the user terminal, acceptance point and central point takes place via mobile telephone connections and/or telephone connections or temporary or permanent communication connections, in particular via the Internet, and/or via short-range communication.

Communication between user terminal, acceptance point and central point can thus take place via various alternative or cumulative communication channels, depending on which option and network coverage is available as well as on the required level of security. In particular, the communication between user terminal, acceptance point and central point can take place in an encrypted manner, that is to say, with the transmitted data and/or data packets, transaction data and transaction number being transmitted in an encrypted manner.

Likewise, different services can be used, such as SMS (mobile telephony) and/or data link (mobile telephony). The communication can also take place via landline, DSL or similar, as well as by utilizing a combination of different services and technologies.

In a preferred embodiment, the request for provision and/or transmission of the transaction number is made by the acceptance point to the central point and/or by a user terminal to the acceptance point and/or by a user terminal to the central point. In particular, the user terminal can be a mobile telephone terminal having an appropriate authentication application.

There are therefore various possibilities which may be used alternatively or cumulatively for performing and implementing the method according to the invention. The different alternatives allow the creation of a wide variety of applications, in particular when transmission routes such as mobile telephone or Internet connections or similar are temporarily or permanently not available. With cumulative application of the different variants, it is possible to establish higher security levels, in particular in the form of multiple or nested or verified authentications.

In a preferred embodiment of the method according to the invention, the transaction number is requested by means of a mobile telephone terminal by means of a first short message and/or USSD, the transaction number being transmitted by the central point by means of a second short message and/or USSD to the mobile telephone terminal.

Through the use of mobile telephone connections and short messages (SMS, Short Message Service) a very high level of security is ensured while at the same time allowing rapid performance of the authentication method, since the central point can send an immediate response to the first request short message. In this respect, the mobile telephone terminal transmits a unique user code, for example in the form of the Mobile Subscriber Integrated Services Digital Network Number (MSISDN), i.e. the subscriber number at which a mobile telephone subscriber can be reached and by means of which a user can be clearly identified, it being possible in an appropriate database of the central point to assign to this user code a user account, for example, or age verification or similar.

Unstructured Supplementary Service Data (USSD) is a transmission service for GSM networks and supports mobile telephone supplementary services.

Preferably, the transaction number is transmitted by the central point via a mobile telephone connection to a mobile telephone terminal or via a telephone connection to a landline telephone. A transmission of this kind to a mobile telephone terminal or a landline telephone can, for example, be done in the form of a short message (SMS), as described above. Alternatively, or cumulatively, it is also possible for the transaction number to be transmitted by a voice service in the form of a voice message that is automatically announced, or in the form of an e-mail or similar.

Alternatively or cumulatively, the transaction number can also be transmitted in the form of a graphics file within a multimedia message (MMS, Multimedia Messaging Service) sent to the mobile telephone terminal. By representing the transaction number as part of a transmitted graphic, the security level of the method according to the invention is increased still further since it is more difficult for an unauthorized third party spy out the transaction number from the graphic than to tap in to a voice message or to listen in, even if only inadvertently.

In a preferred embodiment of the method according to the invention, the transaction number is computed by means of an algorithm. In particular in this respect, a code word and/or a subscriber identification number, in particular MSISDN, IMSI or TIMSI, can form the basis for the computation and/or a code transmitted by short-range communication can form the basis for the computation. The MSISDN is the mobile telephone number, i.e. the Mobile Subscriber Integrated Services Digital Network Number (MSISDN), which is the dialable subscriber number that the caller uses to reach a mobile telephone subscriber. IMSI is the International Mobile Subscriber Identity, and TIMSI is, accordingly, a Temporary International Mobile Subscriber Identity. Clear identification of identity is thus possible by means of the MSISDN, IMSI or TIMSI.

It is especially advantageous in this respect that the security level of the method according to the invention can be increased still further by the having the algorithm run as a hidden process and computing the transaction number immediately upon a request for a transaction number, i.e. making it unnecessary to save and keep a repository of transaction numbers, which could possibly be spyable.

In a further embodiment of the method according to the invention, the transaction number is computed by means of an algorithm both by the acceptance point and by the central point using fixed parameters. In particular in this respect, the date and/or the time of the transaction number requests and/or parameters of a payment transaction, in particular an order number and/or article number and/or an article price and/or a code of the acceptance point and/or the number of active transactions can be used as parameters and thus constitute the basis for computation of the transaction number by means of the algorithm.

In this way, by using an appropriate application, the transaction numbers are computed using an algorithm both at the acceptance point and at the central point, with the algorithm running as a hidden process so that there is no need to store a repository of transaction numbers, which increases the security level still further.

Authentication of the user can then be performed either by the acceptance point issuing the computed transaction number, allowing the user to authenticate himself to the central point, or by the central point providing the computed transaction number to the user who can then use this transaction number to authenticate himself to the acceptance point.

In a preferred embodiment of the method according to the invention, authentication is performed using a transaction number tuple consisting of at least two transaction numbers A and B, the first transaction number A being provided by the acceptance point and the second transaction number B being provided by the central point based on the first transaction number A.

Preferably, a list of unused transaction numbers and/or transaction number tuples is stored temporarily or permanently in an interrogatable manner by the acceptance point.

This makes it possible to include in the method according to the invention even those acceptance points which cannot be connected online to a central point via a telephone and/or Internet connection and/or a mobile telephone connection, by making available one or more lists of transaction numbers and/or transaction number tuples and storing these lists temporarily or permanently in the acceptance point in an interrogatable manner when the acceptance point is being loaded. This makes it possible to achieve complete independence on the part of the acceptance point from the presence of a data link to the central point.

In a preferred embodiment, the method according to the invention is developed such that through the authentication a transaction is authorized and performed, in particular that a shipping or handing over of goods and/or a payment transaction is triggered and performed at the acceptance point, i.e. that through the performance of the authentication a payment transaction, for example, is carried out at an automatic cashier machine or similar.

Preferably, following an authorization message transmitted by the central point to the acceptance point, the user is given access to premises and/or an event, in particular a movie theater, swimming pool, concert or similar.

The method can also be used, once an authorization message has been transmitted by the central point to the acceptance point, for the purpose of allowing the user to utilize a service, in particular a consular, government or similar service.

Likewise, a possible development consists in, once an authorization message has been transmitted by the central point to the acceptance point, allowing the user access to analog or digital data, in particular media such as news, music, video or similar.

Preferably, the method is used to perform a verification and/or ensure compliance with legal provisions, in particular age restrictions and/or voluntary restrictions.

On the one hand, this enables verification of compliance with mandatory statutory provisions, such as a legal age limit, e.g. majority. It also enables verification of compliance with restrictions set by voluntary self-regulation bodies, such as age limits for movies and the like. Likewise, voluntary self-restrictions that users have imposed upon themselves, such as a block for gambling casinos, can also be verified.

Preferably, a numerical or an alphanumerical transaction number (Trx1D) is used.

Preferably, the transaction number (Trx1D) is used to establish a communication link between the acceptance point and the user terminal.

By using the transaction number (Trx1D) to establish a communication link between the acceptance point and the user terminal it is possible to establish a specially coded link in a simple and secure manner.

Preferably, the number of digits of the transaction number (Trx1D) is adapted dynamically, in particular according to the number of parallel active transactions and/or according to the estimated traffic load.

Preferably the temporal re-use of the transaction number (Trx1D) is selected according to the type of acceptance point.

Preferably, the geographical re-use of the transaction number (Trx1D) is selected dynamically according to the country code and/or mobile telephone cells and/or location of the acceptance point.

Preferably, the user triggers the authentication process either by simply sending the transaction number (Trx1D) to the central point or by additionally inputting a personal identifier, in a particular personal password, TAN, iTAN, biometric information, in particular a fingerprint or similar.

Preferably, the acceptance point communicates indirectly with the central point, in particular via one or more aggregators, in particular a district collection point, central computer in the supermarket or similar.

It is therefore not necessary for each single acceptance point to be connected directly or to be directly connectable to the central point since the possibility exists of grouping several acceptance points into units and communicating indirectly with the central point.

Preferably, the subscribers use a variety of communication media, in particular Ethernet, Internet, landlines, radio or mobile telephones and/or different services/protocols, in particular USSD, IP, SMS, GPRS.

In this respect, “subscriber” means any component involved in the authentication process, in particular user terminal, acceptance point, central point, database, etc. Regarding the user terminal, this may be in particular a mobile telephone terminal, but can also be a landline communication terminal such as a telephone or computer.

Alternatively or cumulatively, in the event of faulty, incomplete delivery of the article/provision of a service, non-access to premises or similar, the entire sum or a partial sum plus a possible amount for compensation can be reimbursed.

In the case of a payment transaction, various margins can be automatically deducted/added, such as a currency conversion charge, charge for covering the default risk, processing charges, so that the acceptance point receives a smaller amount and/or the user pays a higher amount.

In this respect, the amount of the currency can already be fixed at the beginning of the transaction or be negotiated between the parties during the transaction, permitting, if necessary, the specification of upper and/or lower limits by one or/and the other subscriber. A tip for service staff can also be included.

An amount can initially be reserved for a defined time and the complete amount or partial amounts be finally posted during this time period, with the remaining amount being automatically released at the end of the time period, unless this has not already been done by the acceptance point by means of a prior message.

It is possible for one or both parties to select the payment means from a subscriber-specific list (either during the transmission of/request for the transaction ID or in the course of a dialog).

The possible payment means can be adapted dynamically by the central point for one or both subscribers and limited as appropriate, for example as a function of payment history, creditworthiness, risk of misuse, turnover amount, number of transactions, etc.

During the authentication and processing of payment transactions, the subscribers (acceptance point and/or user) can use the same or different currencies.

It is also possible to conduct the communication with the subscriber (acceptance point and/or user) in different languages.

In a preferred embodiment, when authorizing the transaction the central point computes a key that is unique and permanently assigned to the user, in particular additionally to the acceptance point, and informs the acceptance point of this key so that previous transactions of the user can be clearly assigned to the user.

In this respect, the key is unique and permanent, at least regarding the user and possibly regarding the combination of user and acceptance point.

An exemplary implementation and application of this variant would be that the customer downloads a payable article from an Internet portal, e.g. Test.de.

Through the “permanent key” the customer is recognized and thus given access to previously purchased articles and can download these.

Furthermore, Test.de, for example, can recognize that the customer is mainly interested in “entertainment electronics” and present appropriate articles (the customer himself does not, however, have to be known).

In a further preferred embodiment, the value of the transaction is equal to 0, in particular the money amount of the transaction is equal to 0, and the user is thus given access to a user account free of charge.

This enables, for example, repeated access to previously purchased and paid articles via a computer network such as the Internet.

Several exemplary embodiments of the method according to the invention are illustrated in the FIGS. and are explained below with reference to the figures, in which:

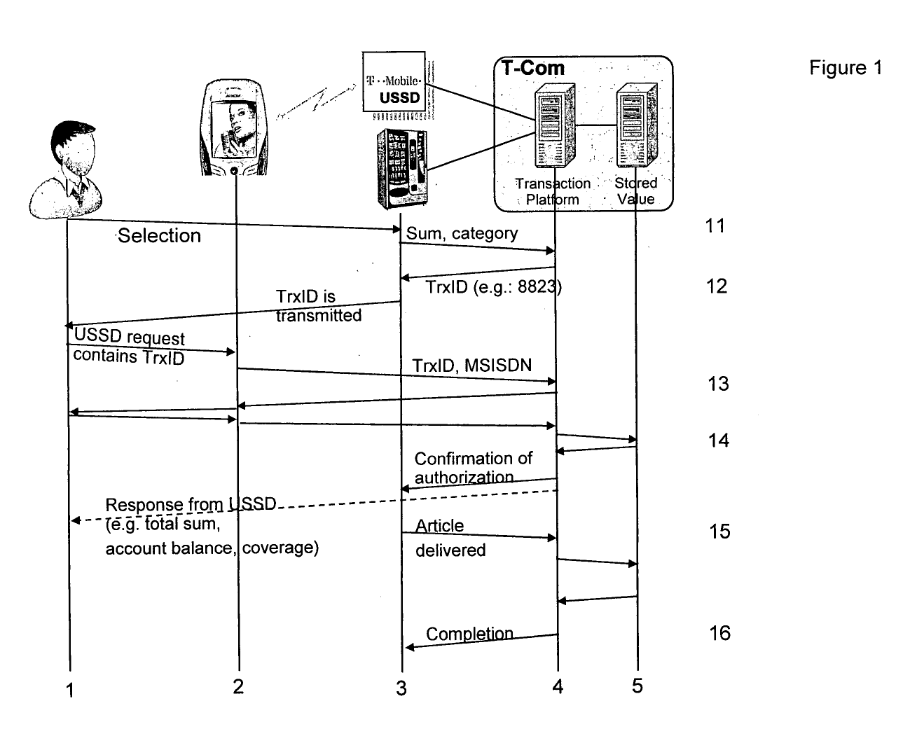

FIG. 1 shows a first embodiment of a method according to the invention for authentication of a user to an acceptance point;

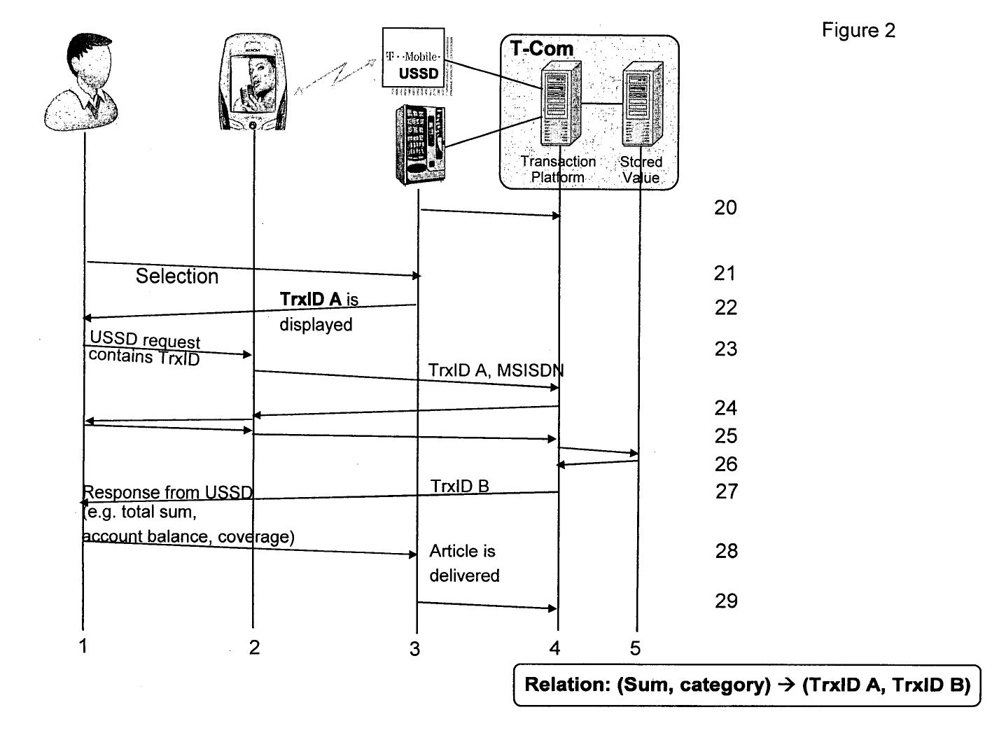

FIG. 2 shows a second embodiment of a method according to the invention for authentication of a user to an acceptance point;

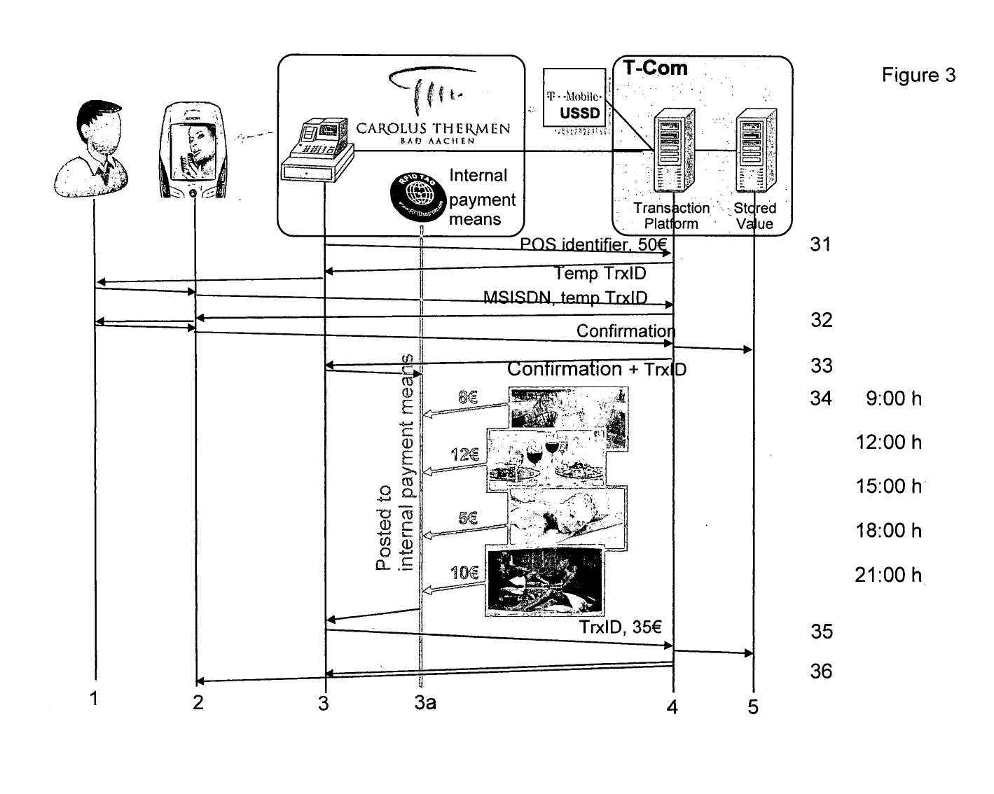

FIG. 3 shows a third embodiment of a method according to the invention for authentication of a user to an acceptance point;

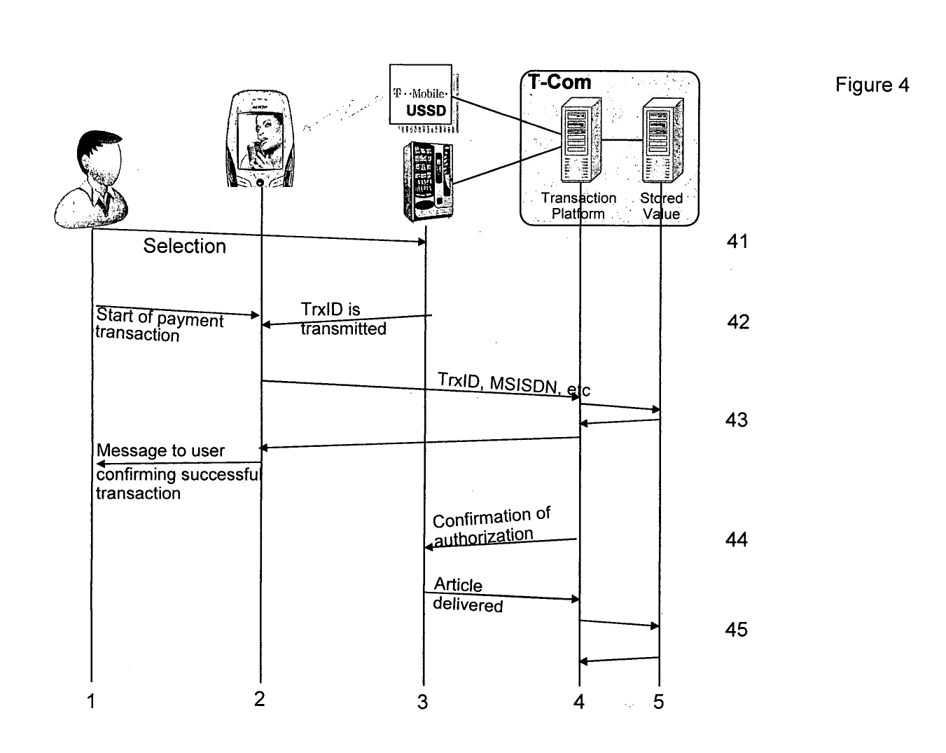

FIG. 4 shows a fourth embodiment of a method according to the invention for authentication of a user to an acceptance point;

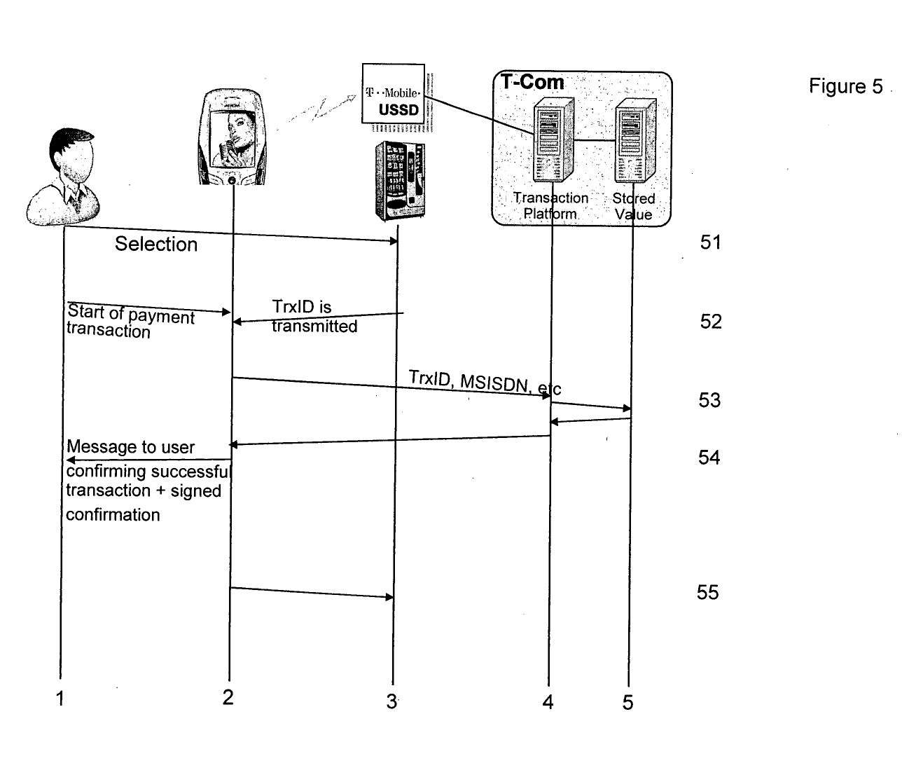

FIG. 5 shows a fifth embodiment of a method according to the invention for authentication of a user to an acceptance point.

FIGS. 1 to 5 illustrate various embodiments and variants of the authentication method according to the invention, in each case as an example in the form of the authentication of a user 1 to an acceptance point in the form of a vending machine 3, with a transaction being authorized by means of the authentication method. In the illustrated examples, the same components are designated by the same reference symbols in each case.

The exemplary embodiment illustrated in FIG. 1 relates to the authentication of a user 1 to an acceptance point in the form of a vending machine 3, the seller and the purchaser being brought together through a temporary transaction ID, i.e. a transaction number Trx1D. This transaction ID Trx1D is used for communication so that no permanent identifier, e.g. account number, etc., requires to be known, that is to say that the user 1 does not have to first register with the acceptance point 3.

For clearing purposes, for example, the transaction can be identified long-term by means of the time stamp of the transaction and the temporary transaction ID or by a unique long-term transaction ID. The long-term transaction ID, i.e. the transaction number, is issued during the transaction, a long-term transaction number being preferred for technical reasons.

The sequence of the method according to the invention is illustrated in FIG. 1. In the form of the vending machine 3, an offer for the dispensing of articles is made available, the user 1 making a corresponding choice by selecting the appropriate item at the vending machine 3, i.e. at the acceptance point, e.g. by entering a code number to identify the article or similar. This causes the vending machine 3 to start the authentication process and the transaction.

Since the user 1, who possesses a mobile telephone terminal 2, which identifies him clearly via the subscriber identification number MSISDN, has not previously been registered at the vending machine 3, the vending machine 3 does not know the MSISDN of the mobile telephone terminal 2.

Having started the transaction, the vending machine 3 requests a temporary transaction number Trx1D from the central point 4, indicating the sum and the goods category as it does so. In the example according to FIG. 1, the transaction number Trx1D “8823” is transmitted from the central point 4 to the acceptance point 3. The acceptance point 3 and the central point 4 are connected for this purpose by a data link for exchanging data, i.e. the acceptance point 3 and the central point 4 have a communication channel. This can, for example, be achieved through an Internet connection, a landline telephone connection or a mobile telephone connection. In the illustrated example, the link between the acceptance point 3 and the central point 4 is, by way of example, an Internet connection.

When a mobile telephone connection is used, different services, such as data link, SMS, USSD, etc. can be used.

The central point thus provides the temporary transaction ID “8823” and informs the acceptance point 3, i.e. the point of sale 3, of this, the acceptance point 3 in its turn transmitting this temporary transaction ID Trx1D 8823 to the user 1. This transmission to the user 1 can be done verbally and/or by means of a display and/or via Internet or similar. Alternatively, the Trx1D can be transmitted by radio (Bluetooth, NFC) or infrared signals.

The user 1 thus has the possibility, by using the mobile telephone terminal 2 and the transaction number Trx1D “8823”, to transmit the latter to the central point 4, for example by sending a short message SMS with an appropriate predefined text, such as “*999#8823”, as in the illustrated example, to the central point. This short message from the mobile telephone terminal 2 to the central point 4 naturally also comprises the subscriber identification number MSISDN in addition to the transaction number Trx1D 8823. This SMS is received by the central point 4 and further processed.

In the illustrated example, this is done by means of a USSD request using the mobile telephone terminal 2. Unstructured Supplementary Service Data (USSD) is a standardized transmission service for GSM networks which supports supplementary mobile telephone services implemented by means of GSM signaling. The access numbers for services of this kind that have to be dialed in order to utilize such services have the format *1 NN#, the “*” and “#” requesting the appropriate service. Via USSD services it is possible, for example, to gain access to preconfigured services that are specific to the operator of the respective mobile telephone network.

The transaction number Trx1D transmitted by the central point 4 to the acceptance point 3 depends on the total number of transaction numbers Trx1D, which again depends on the number of parallel transactions. For example, the transaction number made available can comprise 4 digits as in the example described. The transaction number Trx1D is valid for a limited time.

The length of the Trx1D can be fixed or computed dynamically depending on the parallel transactions/expected parallel transactions.

Using the provided transaction ID (e.g. 8823), the offering can now be requested from the central point 4, the offering being identified by the transaction ID.

The offer data, such as price, product designation and dealer are then displayed as a result of the central point 4 accessing the data stored in the database 5. The user 1 now has the possibility of accepting or rejecting the offer. If the customer 1 confirms the transaction, the sum is authorized and posted via the transaction platform. The central point 4 then confirms the authorization to the acceptance point 3, whereupon the goods are delivered and a corresponding message is sent by the acceptance point 3 to the central point 4. If required, a request to specify the desired payment means can be made to the supplier 3 or user 1 while performing the transaction. Once the article has been issued and the transaction performed, the sum is debited, as shown in FIG. 1, and the process, i.e. the transaction, is completed.

Further variants of the method according to the invention and the performance thereof are possible, for example in the form that the transaction is triggered or started by the user 1.

It is also possible for the transaction to be started by the debtor 1, i.e. the customer, or the creditor 3, i.e. the supplier, without indicating a price or by indicating only a given upper price limit. When the communication link has been established, a price negotiation can take place. The payment transaction is only triggered and only takes place once a price has been agreed.

It is also possible to start the payment transaction by using the central point 4, but with the peers then communicating directly with each other, for example to download general terms and conditions and to deliver the goods, for example in the form of transmitting electronic files via the Internet.

It is possible to use different languages for debtor 1 and creditor 3 during the authentication and performance of the transaction, because the central point 4 and the database 5 are involved as intermediaries.

The re-use interval for transaction numbers, i.e. the transaction INFORMATION DISCLOSURE STATEMENT, can be reduced by using additional information, such as country, mobile telephone cell, etc., which enables shorter transaction numbers to be used. The debtor 1 (customer) and creditor 3 (supplier) can establish their transaction via different communication networks or services, e.g. landline, LAN, W-LAN, GPRS, USSD (radio), voice channel (radio), etc.

In this respect, the characteristics of the dynamically generated transaction identification numbers are such that the number of acceptance points is larger than the number of simultaneous transactions. Since not every acceptance point has its own unique identifier but is assigned a temporary identifier, this can be shorter. Manual input at the terminal becomes simpler as a result. For example, there are more than 600,000 payment machines in the form of vending machines for beverages and cigarettes, but only a few hundred transactions are performed simultaneously in the Federal Republic of Germany.

The length of the transaction numbers depends on the level of traffic. Outside peak periods, for example at night, a very short transaction number can be used, consisting for example of only two digits, that is to say that the length of the transaction numbers can vary according to the level of traffic and, for example, the time of day.

Since the transaction number in the example explained above with reference to FIG. 1 must be requested for each payment transaction, a link from the acceptance point to the transaction platform is required. A link must therefore be established ad hoc or there must be a permanent link.

The individual process steps of the sequence according to FIG. 1 are:
11 Customer 1 selects the desired item at a vending machine 3. Vending machine 3 starts the payment transaction (MSISDN unknown).
12 Temporary transaction ID (Trx1D) is transmitted.

The length of the Trx1D depends on the total number of transaction numbers Trx1D, which depends on the number of parallel transactions (e.g. 4 digits). Transaction number Trx1D is valid for a limited time and is displayed.
13 Customer 1 starts a USSD request, MSISDN and Trx1D are received by the central point 4.
14 Selection of transaction/offer based on the Trx1D. Details are displayed. Customer 1 must confirm the transaction. Sum is authorized and posted (via the transaction platform).
15 Customer 1 is notified of the successful authorization and the sum is debited (response to USSD request). Vending machine 3 receives authorization information, article is delivered.
16 Transaction completed.

In the variant illustrated in FIG. 2 for the performance of a payment transaction by means of stored transaction number tuples, a permanent online link or the establishment of an ad hoc link between the vending machine 3 and the transaction platform 4 is not required, that is to say that the machine 3 in the shown example has no possibility of establishing a permanent online link, for example because the appropriate technology is not available or no radio connection exists, if there is no mobile telephone coverage in the area of the acceptance point 3.

The transaction, i.e. the payment transaction illustrated in the example of FIG. 2, is controlled by means of transaction number tuples consisting of two transaction INFORMATION DISCLOSURE STATEMENT. These tuples are brought to the point of sale 3 beforehand, e.g. manually as part of the process for servicing and/or loading the vending machine 3 or by means of establishing a one-time link via a communication connection.

One of these INFORMATION DISCLOSURE STATEMENT is made known by the creditor 3 (supplier) to the debtor 1 (customer) and the debtor 1 uses it to perform an authorization by using this first transaction number Trx1D A of the transaction number tuple consisting of two transaction numbers A and B.

After successful authorization and execution of the payment transaction, the debtor 1 is notified of the second ID Trx1D B which he notifies to the creditor 3. If this corresponds to the stored second Trx1D B, the article can be delivered. A transaction number tuple consisting of the transaction INFORMATION DISCLOSURE STATEMENT A and B clearly identifies the price and, possibly, the goods category, that is to say that the transaction and/or offer is selected on the basis of the transaction number Trx1D. As illustrated in FIG. 2, the details are displayed and the transaction is confirmed stating the first transaction number A, in particular the sum is debited with the involvement of the database 5 and the central point 4 through the intermediary of which the transaction is executed.

Following provision by the central point 4 of the second transaction number Trx1D B, which is required to complete the transaction number tuple consisting of A and B, through transmission to the mobile telephone terminal 2 of the user 1, the delivery of the article can be triggered using the second transaction number Trx1D B by passing it on to the vending machine 3, upon which a corresponding confirmation of the delivery of the article is sent by the vending machine 3 to the central point 4 as verification of the transaction performed. Alternatively, if the transaction fails, a notification is sent to the effect that a transaction has failed, followed by reimbursement of the posted sum.

The seller, i.e. the creditor 3, thus fetches one or more blocks of transaction number tuples in advance. He needs one block per price and goods category.

When making an offer, the creditor 3 informs the purchaser, i.e. the debtor 1, of a transaction ID A of a tuple that matches the goods category/price, for example by displaying it on the vending machine 3.

The debtor 1 performs an authorization of the transaction by indicating the notified transaction ID A. In doing so, he receives information on the offer, e.g. price, goods category, seller, etc.

If the debtor 1 accepts the offer, he receives a second transaction ID B from the central point 4, by means of which he can authenticate himself to the creditor 3, by informing the creditor 3 of the second transaction ID B, for example through automatic forwarding from the user terminal 2 to the vending machine 3.

The creditor 3 checks whether the notified second transaction ID B matches his first transaction ID A, i.e. whether this is a correct transaction number tuple consisting of A and B. If the answer is yes, the goods are delivered.

In one variant of the method according to the invention, the creditor 3 is clearly identified through the transaction ID, or alternatively, the debtor 1 must additionally enter a dealer identifier code in the application. The re-use interval for identification numbers can be reduced by using additional information, such as country, mobile telephone cell, etc., which enables shorter identification numbers and identification number tuples to be used.

In a further variant, the transaction, i.e. the authentication, is performed by means of a transaction number tuple, but unlike the preceding example, the transaction number tuples are not stored in lists, but are computed on a case-by-case basis upon request, i.e. upon triggering of an authentication process, by means of an algorithm.

Here, the purchaser (debtor) informs the central point of the transaction data such as dealer, acceptance point, goods category by using the appropriate application in his mobile telephone terminal. Based on the transaction data, both the acceptance point and the central point each compute a key. The central point sends the key it has computed to the debtor, i.e. to the customer, who forwards it to the creditor, e.g. by inputting it on the keypad of the mobile telephone terminal, or similar. If the two keys match, the goods can be delivered. To compute the key, not only the transaction data are used but also, in particular, secret data, such as a personal code which has to be entered, or also variable data, such as the time at which the transaction was triggered.

An exemplary sequence of an authorization and transaction process of this kind could be as follows: The debtor 1 selects an article and enters the transaction data with details on the dealer, the acceptance point and the goods category in the appropriate transaction application of his mobile telephone terminal 2. This transaction application or payment application transmits the data to the central point 4 which computes the key Trx1D and transmits this back to the payment application of the mobile telephone terminal 2. Using the key received from the central point 4, the customer 1 can authenticate himself to the acceptance point 3 by means of his mobile telephone terminal 2. The acceptance point 3 in its turn computes the key Trx1D to check the key, i.e. the transaction number.

If the keys match, i.e. the key sent by the central point 4 is identical with the key computed by the acceptance point 3, the article is delivered.

The individual process steps of the sequence according to FIG. 2 are:
Request for transaction numbers TrxIDs for each combination (price and category). Trx1D A and Trx1D B are received.
21 Customer 1 selects the desired article at a vending machine 3 or similar.
22 Vending machine 3 selects unused Trx1D A to match the selected article. Trx1D A is displayed.
23 Customer 1 starts USSD request with Trx1D A (Trx1D A must be unique, i.e. very long or, alternatively, an additional identifier to identify the vending machine 3 must be used).
24 Selection of transaction/offer based on Trx1D A.
25 Details are displayed. Transaction is confirmed.
26 Sum is debited.
27 USSD response contains Trx1D B. Trx1D B can be shorter than Trx1D A, just sufficiently long to ensure that Trx1D B cannot be guessed.
28 Trx1D B is transmitted to vending machine 3. If

Trx1D B matches Trx1D A, the article is issued. If necessary, renewed input of the ID, 10 seconds waiting time in the event of wrong input of ID.
29 Request for new transaction numbers (Trx1D A, Trx1D B), notification of failed transactions→reimbursement, information about successful transactions (for verification).

Shown in FIG. 3 is a further example in which by means of one single authentication a log-in occurs, and already upon logging in a sum is reserved for the payment of individual partial sums. In the shown example, this is EUR 50. If the customer now utilizes various services of the acceptance point 3, individual partial sums are posted via an internal payment means from a prepaid account on an RFID chip 3a (Radio Frequency Identification) to the acceptance point 3. When checking out, the sum used, which is EUR 35 in the shown example, is posted as the final amount. Following this, both the mobile telephone terminal 2 which was used for authentication to the acceptance point 3 and the central point 4 and the database 5 connected thereto are informed about the postings so that a payment transaction can be performed to complete the process.

Especially advantageous in the illustrated method of authentication and in particular for the execution and triggering of payment transactions is that the customer does not have to reveal his identity to the seller. In this instance, the seller can be a vending machine, an automatic cashier machine, a taxi, any point of sale, an Internet shop or similar.

A further advantage is the high security of the authentication process, since customer data cannot be misused, such as would be possible, for example, with a credit card number or in the event of manipulation of the EC card terminal at an acceptance point such as a supermarket or similar. Authorization is performed online in an especially advantageous manner and with a very high level of security.

Security is further increased by using different communication media. That is to say, Trojans, “man in the middle” attacks are avoided with a high level of probability, since both communication media would have to be infected.

Duplicates cannot occur in this respect since the transaction ID is unique within a time period and is only temporarily valid.

Various payment means can be selected by the debtor and, possibly, by the creditor. It is not necessary in this respect for the other party to know about the chosen payment means. For example, a distinction can be made between a private prepaid account and a company prepaid account. That is to say, the payment means used can, in particular, also be stored-value (prepaid) or debit card or credit card. It is also possible to handle payment by direct debiting, the customer having only to first register with the central point in this case, but, as before, not with the acceptance point, thus ensuring the anonymity of the customer with respect to the acceptance point.

The authentication and the transaction are authorized centrally to reduce the possibility of misuse through theft (PIN input, biometric information) or uncollectible receivables, i.e. the transaction is not authorized by the machine or by an employee at the point of sale but via the central system. It is possible to provide for a restriction with respect to the payment means, i.e. a personal limit or similar. At the same time, compliance with conditions of sale, such as an age limit, is possible by verifying customer data and/or by inputting a personal PIN/biometric information or similar.

In addition to the actual payment transaction, questions regarding tipping or similar can be put during the customer dialog. Such a tip, if confirmed, leads to a, possibly limited, second payment transaction, e.g. a transaction which is posted separately, for instance to the “service staff account.” In another variant, only one single transaction payment is executed, i.e. the sum to be paid is increased by the amount of the tip, as is known from credit card transactions.

Depending on the business process, the purchaser (customer) can, however, reveal his identity, if for example, he consents to the transmission of his subscriber identification number MSISDN by the central point to the acceptance point when using a mobile telephone terminal for the authorization. In this respect, identity may be his “real identity” or a fictitious identity.

It is possible to reduce the transaction sum if a maximum sum has been fixed by the creditor at the beginning of the transaction. Post-authorization, i.e. increasing the payment sum, can then only be performed through further confirmation by the debtor, i.e. the customer. In such a case, a second transaction must be triggered through a second authorization. It is possible for unused sums, or sums that have not been charged as final, to be reimbursed, such as shown in the third example in FIG. 3, in which a total amount of EUR 50 was authorized at the beginning, of which only a partial sum of EUR 35 has been used.

By means of the unique transaction number, i.e. a temporary transaction ID plus time stamp or a long-term transaction ID assigned during the transaction, the transaction can be reproduced. The long-term transaction number is notified to both parties, e.g. in transaction overviews or a monthly account statement or similar. This information can also be used for further verifications, such as clearing.

The individual process steps of the sequence according to FIG. 3 are:
31 Cashier machine starts “reservation”, the sum to be reserved being specified and a temporary transaction ID generated.
32 The Trx1D is displayed to the customer. He, in turn, starts a transaction by stating the ID and receives further details (how much, who, etc.). The customer confirms the transaction and the sum is reserved.
33 Notification of successful reservation and assignment of a long-term Trx1D. Internal payment means is charged.
34 Customer “consumes.” The time is stated.
35 When “checking out”, the sum used is charged as final.
36 Customer and cashier machine are informed about the successful posting.

Illustrated in FIGS. 4 and 5 are two further embodiments of the authentication method according to the invention, by means of which a customer 1 can authenticate himself to a vending machine 3 and can authorize and perform a payment transaction via the intermediary of the central point 4.

The authentication process is triggered by the customer 1 using a mobile telephone terminal 2 by using data transmitted by the vending machine 3 to the terminal 2. These data include the transaction number Trx1D provided by the vending machine 3. The data is transmitted from the vending machine 3, i.e. from the acceptance point 3, to the terminal 2 via short-range communication. The message to start the transaction is sent to the central point 4, i.e. to the transaction platform. The data transmitted by the mobile telephone terminal 2 to the transaction platform, i.e. the central point 4 comprise, on the one hand, the transaction number Trx1D provided by the vending machine 3 as well as, additionally, the MSISDN serving to identify the user 1. The transaction number Trx1D and the MSISDN identifying the user 1 are transmitted by the terminal 2 to the central point 4 via the mobile telephone network.

The transaction data are then processed as appropriate by the central point 4 and the connected database 5. The account of the customer 1 is debited accordingly and, once the central point 4 has received a corresponding confirmation from the processing unit and the database 5 it generates a confirmation message which is transmitted, again via the mobile telephone network, to the terminal 2 of the user 1 for display and further processing.

At the same time, a confirmation message is generated by the central point 4 and transmitted to the acceptance point 3, whereupon the acceptance point 3, i.e. the vending machine 3, delivers the article. The vending machine 3 sends a confirmation back to the central point 4 stating that the goods have been delivered. This notification by the acceptance point 3 to the central point 4 concerning the successful completion of the transaction is forwarded by the central point 4 to the connected data processing unit 5, which reconfirms it to the central point 4.

The individual process steps of the sequence according to FIG. 4 are:
41 Customer 1 selects the desired article at a vending machine 3. Vending machine 3 starts transaction.
42 Customer starts payment transaction (authentication) using the data transmitted by the machine to the terminal (e.g. by means of NFC, RFID). The message to start the transaction is sent to the central point, i.e. transaction platform.
43 The customer's account is debited and the customer receives an optional confirmation message regarding the successful transaction.
44 The machine receives a confirmation of the transaction which it can clearly relate to the original transaction since, for example, a key was used which was computed based on the original transaction ID.
45 Depending on the business process, i.e. if delivery of the article can fail, the machine sends a message to the central point stating that the article was successfully delivered.

The process illustrated in FIG. 5 differs from that in FIG. 4 in that, after receiving the transaction number Trx1D and MSISDN by means of a message from the terminal 2 to identify the intended transaction on the one hand and the user 1 on the other hand, the central point 4 generates a confirmation message which is also signed by the central point 4 by means of a confirmation with signature. This signed confirmation is transmitted by the central point 4 directly to the terminal 2, whereupon the terminal 2 can use this transaction confirmation signed by the central point 4 to authenticate itself to the acceptance point 3 via a short-range communication link, so that the acceptance point 3, in this case the vending machine 3, can deliver the article.

The individual process steps of the sequence according to FIG. 5 are:
51 Customer 1 selects the desired article at a vending machine 3. Vending machine 3 starts the transaction.
52 Customer starts payment transaction using the data transmitted by the machine to the terminal 2 (e.g. by means of NFC, RFID). The message to start the transaction is sent to the central point 4, i.e. the transaction platform.
53 The customer's account is debited and the customer receives an optional confirmation message regarding the successful transaction.
54 Furthermore, a confirmation of the successful transaction signed by the central point 4 (transaction platform) is sent to the terminal 2 of the user. The user or the terminal 2 of the user transmits the information by NFC or RFID to the acceptance point 3 (signed: e.g. private/public key method, “secret” algorithm.
55 The confirmation of the transaction is sent to the machine 3 (acceptance point), which delivers the article.

In the examples shown in FIGS. 4 and 5, the communication between the user terminal 2 and the central point 4 thus takes place via the mobile telephone network. The communication between user terminal 2 and acceptance point 3, on the other hand, takes place by short-range communication such as NFC or RFID.

In the examples illustrated in FIGS. 4 and 5, the transaction number Trx1D is provided by the acceptance point 3 after the authentication process has been started, the authentication to the central point 4 being performed by generation of a corresponding message by the terminal 2. This message from the terminal 2 contains not only the transaction number Trx1D but also the subscriber identification number MSISDN, by means of which the user 1 can be identified.

1-26. (canceled)

27. A method of authentication of a user to an acceptance point, the authentication being performed by comparing a transaction number with a computed or stored transaction number, wherein the acceptance point or a user terminal sends a request message to a central point and the central point provides and transmits a temporarily valid transaction number by means of which authentication of the user to the acceptance point can be performed, or that the acceptance point provides a temporarily valid transaction number by means of which authentication of the user to the central point can be performed, an authorization after successful authentication to the central point being performed by the generation and transmission of an authorization message from the central point to the acceptance point, whereas the request for provision or transmission of the transaction number is sent by the acceptance point to the central point or by a user terminal to the acceptance point or to the central point, in particular by a mobile telephone terminal having an appropriate authentication application.

28. The method according to claim 27, wherein the authentication process is triggered by a user through a personal code, in particular a password, a single-use transaction number or biometric identification, in particular a fingerprint or similar.

29. The method according to claim 27, wherein the indication of a personal code for triggering the authentication process is required in every case or that the request is made depending on the current situation, in particular depending on the total turnover of the user within a time interval, the magnitude of the sum involved, the history of the customer, the type of article or other customer-specific characteristics.

30. The method according to claim 27, wherein the communication between the user terminal, acceptance point and central point takes place via mobile telephone connections or telephone connections or temporary or permanent communication connections, in particular via the Internet, or via short-range communication.

31. The method according to claim 27, wherein the transaction number is requested by means of a mobile telephone terminal in a first short message or by USSD, and that the transaction number is transmitted by the central point in a second short message or by USSD to the mobile telephone terminal.

32. The method according to claim 27, wherein the transaction number is transmitted by the central point via a mobile telephone connection to a mobile telephone terminal or via a telephone connection to a landline telephone.

33. The method according to claim 27, wherein the transaction number is computed by means of an algorithm, whereby in particular a code word or a subscriber identification number of a mobile telephone subscriber, in particular MSISDN, IMSI or TIMSI, forms the basis for the computation or a code transmitted by short-range communication forms the basis for the computation.

34. The method according to claim 27, wherein the transaction number is computed by means of an algorithm, both by the acceptance point and by the central point using fixed parameters, in particular that the parameters used are the date or the time of the request or parameters of a payment transaction, in particular an order number or article number or article price, or a code of the acceptance point or the number of active transactions.

35. The method according to claim 27, wherein for authentication a transaction number tuple consisting of at least two transaction numbers is used, a first transaction number being provided by the acceptance point and a second transaction number being provided by the central point based on the first transaction number.

36. The method according to claim 27, wherein the acceptance point has a list of unused transaction numbers or transaction number tuples stored temporarily or permanently in an interrogatable manner.

37. The method according to claim 27, wherein by means of the authentication a transaction is authorized and performed, in particular that a shipping of articles or delivery of articles at the acceptance point or payment transaction is triggered and performed.

38. The method according to claim 27, wherein following an authorization message transmitted by the central point to the acceptance point, the user is given access to premises or an event, in particular a movie theater, swimming pool, concert or similar.

39. The method according to claim 27, wherein following an authorization message transmitted by the central point to the acceptance point, the user is permitted to utilize a service, in particular a consular, government or similar service.

40. The method according to claim 27, wherein following an authorization message transmitted by the central point to the acceptance point, the user is given access to analog or digital data, in particular media such as news, music, video or similar.

41. The method according to claim 27, wherein the method is used to perform a verification or ensure compliance with legal provisions, in particular age restrictions or voluntary restrictions.

42. The method according to claim 27, wherein a numerical or alphanumerical transaction number is used.

43. The method according to claim 27, wherein by using the transaction number a communication link is established between the acceptance point and the user terminal.

44. The method according to claim 27, wherein the number of digits of the transaction number is adapted dynamically, in particular according to the number of parallel active transactions or according to the estimated traffic load.

45. The method according to claim 27, wherein the temporal re-use of the transaction number is selected according to the type of acceptance point.

46. The method according to claim 27, wherein the geographical re-use of the transaction number is selected dynamically according to the country code or mobile telephone cells or location of the acceptance point.

47. The method according to claim 27, wherein the user triggers the authentication process either by simply sending the transaction number to the central point or by additionally inputting a personal identifier, in a particular personal password, TAN, iTAN, biometric information, in particular a fingerprint or similar.

48. The method according to claim 27, wherein the acceptance point communicates indirectly with the central point, in particular via one or more aggregators, in particular a district collection point, central computer in the supermarket or similar.

49. The method according to claim 27, wherein the subscribers use a variety of communication media, in particular Ethernet, Internet, landlines, radio or mobile telephones or different services/protocols, in particular USSD, IP, SMS, GPRS.

50. The method according to claim 27, wherein when authorizing the transaction the central point computes a key that is unique and permanently assigned to the user, in particular additionally to the acceptance point, and informs the acceptance point of this key so that previous transactions of the user can be clearly assigned to the user.

51. The method according to claim 27, wherein the value of the transaction, in particular the money amount of the transaction, is equal to 0 and the user is thus given access to a user account free of charge.
